(19) United States
(12) Patent Application Publication
(10) Pub. No.: US 2025/0019300 A1
(43) Pub. Date: Jan. 16, 2025

(54) LASER BONDING OF GLASS TO THICK METAL FOIL

(71) Applicant: CORNING INCORPORATED, CORNING, NY (US)

(72) Inventors: Stephan Lvovich Logunov, Corning, NY (US); Mark Alejandro Quesada, Horseheads, NY (US)

(21) Appl. No.: 18/714,377

(22) PCT Filed: Nov. 29, 2022
(86) PCT No.: PCT/US2022/051174

§ 371 Date: May 29, 2024

Related U.S. Application Data
(60) Provisional application No. 63/284,156, filed on Nov. 30, 2021.

(51) Int. Cl. C03C 27/02

(52) U.S. Cl. CPC C03C 27/02

(57) ABSTRACT

A method of bonding glass to metal foil comprising contacting a glass substrate and a metal foil to create an interface therebetween; and directing a laser beam operating at a predetermined wavelength onto the interface to form an interfacial weld between the glass substrate and the metal foil, wherein the metal foil has a thickness greater than or equal to 5 μm and less than or equal to 200 μm, and wherein the laser beam comprises a pulsed laser having a pulse width greater than or equal to 1 nanosecond and less than or equal to 200 nanoseconds. In other embodiments, the metal foil has a thickness greater than 100 nm and less than or equal to 10 mm.

### CROSS-REFERENCE TO RELATED APPLICATIONS

This application claims the benefit of priority under 35 U.S.C. § of U.S. Provisional Application No. 63/284,156 filed Nov. 30, 2021, the content of which is incorporated herein by reference in its entirety.

### FIELD

The present specification generally relates to glass bonded to metal foil and, in particular, to laser bonding of glass to thick metal foil.

### Technical Background

Hermetically welded glass articles are increasingly popular for application to electronics and other devices that may benefit from a hermetic environment for sustained operation. Conventional glass-to-glass laser bonding methods may use a thin metal film (e.g., less than or equal to 100 nm) as an absorbing layer to create heat such that the glass melts and bonds. However, the thin metal film may dissolve during such conventional methods and not be available for further processing after welding.

Accordingly, a need exists for an alternative method to produce welded glass and metal foil articles such that the metal foil may be further processed (e.g., patterned) after welding.

### SUMMARY

According to a first aspect A1, a method of bonding glass to metal foil may comprise: contacting a glass substrate and a metal foil to create an interface therebetween; and directing a laser beam operating at a predetermined wavelength onto the interface to form an interfacial weld between the glass substrate and the metal foil, wherein the metal foil has a thickness greater than or equal to 5 μm and less than or equal to 200 μm, and wherein the laser beam comprises a pulsed laser having a pulse width greater than or equal to 1 nanosecond and less than or equal to 200 nanoseconds.

A second aspect A2 includes the method according to the first aspect A1, wherein the interfacial weld is a hermetic seal between the glass substrate and the metal foil.

A third aspect A3 includes the method according to the first aspect A1 or the second aspect A2, wherein the pulsed laser comprises a wavelength greater than or equal 260 nm and less than or equal to 2500 nm.

A fourth aspect A4 includes the method according to any one of the first through third aspects A1-A3, wherein the pulsed laser comprises a repetition rate greater than or equal to 1 kHz and less than or equal to 1000 KHz.

A fifth aspect A5 includes the method according to any one of the first through fourth aspects A1-A4, wherein the pulsed laser comprises a focal spot diameter greater than or equal to 5 μm and less than or equal to 300 μm.

A sixth aspect A6 includes the method according to any one of the first through fifth aspects A1-A5, wherein the pulsed laser comprises an energy density greater than or equal to 0.1 J/cm² and less than or equal to 100 J/cm².

A seventh aspect A7 includes the method according to any one of the first through sixth aspects A1-A6, wherein the pulsed laser comprises a peak power density greater than or equal to 0.005 GW/cm² and less than or equal to 10 GW/cm².

An eighth aspect A8 includes the method according to any one of the first through seventh aspects A1-A7, wherein the pulsed laser has a peak power greater than or equal to 50 W and less than or equal to 10 kW.

A ninth aspect A9 includes the method according to any one of the first through eighth aspects A1-A8, wherein the pulsed laser has an average power greater than or equal to 0.5 W and less than or equal to 5 W at 30 kHz repetition rate.

A tenth aspect A10 includes the method according to any one of the first through ninth aspects A1-A9, wherein the method further comprises forming a pattern on the metal foil after forming the interfacial weld.

An eleventh aspect A11 includes the method according to any one of the first through tenth aspects A1-A10, wherein the glass substrate comprises a glass or glass-ceramic comprising silica, soda-lime silicate, aluminosilicate, alkali-aluminosilicate, borosilicate, alkali-borosilicate, aluminoborosilicate, and alkali-alumino-borosilicate, or alkali-aluminosilicate.

A twelfth aspect A12 includes the method according to any one of the first through eleventh aspects A1-A11, wherein the metal foil comprises aluminum or an aluminum alloy.

According to a thirteenth aspect A13, a welded article may comprise: a first glass substrate; a metal foil; a first interfacial weld between the first glass substrate and the metal foil, wherein the metal foil has a thickness greater than or equal to 5 μm and less than or equal to 200 μm, and wherein the first interfacial weld comprises weld lines having a width greater than or equal to 5 μm and less than or equal to 1 mm and a distance between weld lines greater than or equal to 1 μm and less than or equal to 1000 μm.

A fourteenth aspect A14 includes the article according to the thirteenth aspect A13, wherein the welded article has a surface energy bond strength greater than or equal to 0.2 J/m² and less than or equal to 3.0 J/m².

A fifteenth aspect A15 includes the article according to the thirteenth aspect A13 or fourteenth aspect A14, wherein the welded article has a residual stress less than or equal to 30 MPa.

A sixteenth aspect A16 includes the article according to any one of the thirteenth through fifteenth aspects A13-A15, wherein the first interfacial weld is a hermetic scal between the first glass substrate and the metal foil.

A seventeenth aspect A17 includes the article according to any one of the thirteenth through sixteenth aspects A13-A16, wherein the metal foil is a patterned metal foil.

An eighteenth aspect A18 includes the article according to any one of the thirteenth through seventeenth aspects A13-A17, wherein the welded article further comprises a second glass substrate and a second interfacial weld between the second glass substrate and the metal foil.

A nineteenth aspect A19 includes the article according to any one of the thirteenth through eighteenth aspects A13-A18, wherein the first glass substrate comprises a glass or glass-ceramic comprising silica, soda-lime silicate, aluminosilicate, alkali-aluminosilicate, borosilicate, alkali-borosilicate, aluminoborosilicate, and alkali-alumino-borosilicate, or alkali-aluminosilicate.

A twentieth aspect A20 includes the article according to any one of the thirteenth through nineteenth aspects A13-A19, wherein the metal foil comprises aluminum or an aluminum alloy.

According to a twenty-first aspect A21, a method of bonding glass to metal foil may comprise: contacting a glass substrate and a metal foil to create an interface therebetween; and directing a laser beam operating at a predetermined wavelength onto the interface to form an interfacial weld between the glass substrate and the metal foil, wherein the metal foil has a thickness greater than 100 nm and less than or equal to 10 mm, and wherein the laser beam comprises a pulsed laser having a pulse width greater than or equal to 1 nanosecond and less than or equal to 200 nanoseconds.

A twenty-second aspect A22 includes the method according to the twenty-first aspect A21, wherein the interfacial weld is a hermetic seal between the glass substrate and the metal foil.

A twenty-third aspect A23 includes the method according to the twenty-first aspect A21 or the twenty-second aspect A22, wherein the pulsed laser comprises a wavelength greater than or equal 260 nm and less than or equal to 2500 nm.

A twenty-fourth aspect A24 includes the method according to any one of the twenty-first through twenty-third aspects A21-A23, wherein the pulsed laser comprises a repetition rate greater than or equal to 1 kHz and less than or equal to 1000 kHz.

A twenty-fifth aspect A25 includes the method according to any one of the twenty-first through twenty-fourth aspects A21-A24, wherein the pulsed laser comprises a focal spot diameter greater than or equal to 5 μm and less than or equal to 300 μm.

A twenty-sixth aspect A24 includes the method according to any one of the twenty-first through twenty-third aspects A21-A25, wherein the pulsed laser comprises an energy density greater than or equal to 0.1 J/cm² and less than or equal to 100 J/cm².

A twenty-seventh aspect A27 includes the method according to any one of the twenty-first through twenty-sixth aspects A21-A26, wherein the pulsed laser comprises a peak power density greater than or equal to 0.005 GW/cm² and less than or equal to 10 GW/cm².

A twenty-eighth aspect A28 includes the method according to any one of the twenty-first through twenty-seventh aspects A21-A27, wherein the pulsed laser has a peak power greater than or equal to 50 W and less than or equal to 10 KW.

A twenty-ninth aspect A29 includes the method according to any one of the twenty-first through twenty-eighth aspects A21-A28, wherein the pulsed laser has an average power greater than or equal to 0.5 W and less than or equal to 5 W at 30 kHz repetition rate.

A thirtieth aspect A30 includes the method according to any one of the twenty-first through twenty-ninth aspects A21-A29, wherein the method further comprises forming a pattern on the metal foil after forming the interfacial weld.

A thirty-first aspect A31 includes the method according to any one of the twenty-first through thirtieth aspects A21-A30, wherein the metal foil comprises a first metal layer and a second metal layer.

A thirty-second aspect A32 includes the method according to the thirty-first aspect A31, wherein the first metal layer comprises aluminum, manganese, tantalum, chromium, cobalt, magnesium, iron, titanium, or a combination thereof.

A thirty-third aspect A33 includes the method according to the thirty-first aspect A31 or the thirty-second aspect A32, wherein the second metal layer comprises copper, silver, gold, molybdenum, titanium, aluminum, stainless steel, nickel, tungsten, bronze, iron, any alloy thereof, or a combination thereof.

A thirty-fourth aspect A34 includes the method according to any one of the thirty-first through thirty-third aspects A31-A33, wherein the first metal layer has a thickness greater than or equal to 10 nm and less than or equal to 15 μm.

A thirty-fifth aspect A35 includes the method according to any one of the thirty-first through thrity-fourth aspects A31-A34, wherein the second metal layer has a thickness greater than or equal to 100 nm and less than or equal to 10 mm.

A thirty-sixth aspect A36 includes the method according to any one of the thirty-first through thrity-fifth aspects A31-A35, wherein the metal foil further comprises a first metal adhesion layer between the first metal layer and the second metal layer.

A thirty-seventh aspect A37 includes the method according to the thirty-sixth aspect A36, wherein the first metal adhesion layer comprises chromium, tungsten, tantalum, titanium, niobium, any alloy thereof, or a combination thereof.

A thirty-eighth aspect A38 includes the method according to the thirty-sixth aspect A36 or the thirty-seventh aspect A37, wherein the first metal adhesion layer has a thickness greater than or equal to 1 nm and less than or equal to 250 nm.

A thirty-ninth aspect A39 includes the method according to any one of the twenty-first through thirty-eighth aspects A21-A38, wherein the glass substrate comprises a glass or glass-ceramic comprising silica, soda-lime silicate, aluminosilicate, alkali-aluminosilicate, borosilicate, alkali-borosilicate, aluminoborosilicate, and alkali-alumino-borosilicate, alkali-aluminosilicate, or inorganic oxide.

According to a fortieth aspect A40, a welded article may comprise: a first glass substrate: a metal foil; a first interfacial weld between the first glass substrate and the metal foil, wherein the metal foil has a thickness greater than 100 nm and less than or equal to 10 mm, and wherein the first interfacial weld comprises weld lines having a width greater than or equal to 5 μm and less than or equal to 1 mm and a distance between weld lines greater than or equal to 1 μm and less than or equal to 1000 μm.

A forty-first aspect A41 includes the article according to the fortieth aspect A40, wherein the welded article has a surface energy bond strength greater than or equal to 0.2 J/m² and less than or equal to 3.0 J/m².

A forty-second aspect A42 includes the article according to the fortieth aspect A40 or the forty-first aspect A41, wherein the welded article has a residual stress less than or equal to 50 MPa.

A forty-third aspect A43 includes the article according to any one of the fortieth through forty-second aspects A40-A42, wherein the first interfacial weld is a hermetic seal between the first glass substrate and the metal foil.

A forty-forth aspect A44 includes the article according to any one of the fortieth through forty-third aspects A40-A43, wherein the metal foil is a patterned metal foil.

A forty-fifth aspect A45 includes the article according to any one of the fortieth through forty-fourth aspects A40-A44, wherein the welded article further comprises a second glass substrate and a second interfacial weld between the second glass substrate and the metal foil.

A forty-sixth aspect A46 includes the article according to any one of the fortieth through forty-fifth aspects A40-A45, wherein the metal foil comprises a first metal layer and a second metal layer.

A forty-seventh aspect A47 includes the article according to the forty-sixth aspect A46, wherein the first metal layer comprises aluminum, manganese, tantalum, chromium, cobalt, magnesium, iron, titanium, or a combination thereof.

A forty-eighth aspect A48 includes the article according to the forty-sixth aspect A46 or the forty-seventh aspect A47, wherein the second metal layer comprises copper, silver, gold, molybdenum, titanium, aluminum, stainless steel, nickel, tungsten, bronze, iron, any alloy thereof, or a combination thereof.

A forty-ninth aspect A49 includes the article according to any one of the forty-sixth through forty-eighth aspects A46-A48, wherein the first metal layer has a thickness greater than or equal to 10 nm and less than or equal to 15 μm.

A fiftieth aspect A50 includes the article according to any one of the forty-sixth through forty-ninth aspects A46-A49, wherein the second metal layer has a thickness greater than or equal to 100 nm and less than or equal to 10 mm.

A fifty-first aspect A51 includes the article according to any one of the forty-sixth through fiftieth aspects A46-A50, wherein the metal foil further comprises a first metal adhesion layer between the first metal layer and the second metal layer.

A fifty-second aspect A52 includes the article according to the fifty-first aspect A51, wherein the first metal adhesion layer comprises chromium, tungsten, tantalum, titanium. niobium, any alloy thereof, or a combination thereof.

A fifty-third aspect A53 includes the article according to the fifty-first aspect A51 or the fifty-second aspect A52, wherein the first metal adhesion layer has a thickness greater than or equal to 1 nm and less than or equal to 250 nm.

A fifty-fourth aspect A54 includes the article according to any one of the fortieth through fifty-third aspects A40-A53, wherein the first glass substrate comprises a glass or glass-ceramic comprising silica, soda-lime silicate, aluminosilicate, alkali-aluminosilicate, borosilicate, alkali-borosilicate, aluminoborosilicate, and alkali-alumino-borosilicate, or alkali-aluminosilicate.

Additional features and advantages of the laser bonding methods described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a flow diagram of a method of bonding glass to metal foil, according to one or more embodiments shown and described herein;

FIG. 2 schematically depicts a step of the laser bonding method, according to one or more embodiments shown and described herein;

FIG. 3 schematically depicts a welded article, according to one or more embodiments shown and described herein;

FIG. 4 schematically depicts an alternative metal foil, according to one or more embodiments shown and described herein;

FIG. 5 schematically depicts another step of the laser bonding method, according to one or more embodiments shown and described herein;

FIG. 6 is a schematic top view of the step shown in FIG. 5;

FIG. 7 is a schematic of a “razor blade test” for measuring surface energy bond strength, according to one or more embodiments shown and described herein;

FIG. 8 schematically depicts another step of the laser bonding method, according to one or more embodiments shown and described herein;

FIG. 9 schematically depicts a welded article including an alternative metal foil, according to one or more embodiments shown and described herein;

FIG. 10 schematically depicts another welded article including another alternative metal foil, according to one or more embodiments shown and described herein;

FIG. 11 is a dark field microscope image at 50× magnification of a metal foil side of a weld line according to one or more embodiments shown and described herein;

FIG. 12 the dark field microscope image of FIG. 11 at 200× magnification;

FIG. 13 is a photograph of a welded article after being subjected to the “razor blade test” according to one or more embodiments shown and described herein;

FIG. 14 is an image of optical birefringence of welded article, according to one or more embodiments shown and described herein;

FIG. 15 is a plot of residual stress versus depth (y-axis: residual stress (MPa); x-axis: depth (μm)) taken at a first point along the welded article shown in FIG. 14;

FIG. 16 is a plot of residual stress versus depth (y-axis: residual stress (MPa); x-axis: depth (μm)) taken at a second point along the welded article shown in FIG. 14;

FIG. 17 is a plot of residual stress versus depth (y-axis: residual stress (MPa); x-axis: depth (μm)) taken at a third point along the welded article shown in FIG. 14;

FIG. 18 is a photograph of a welded article, according to one or more embodiments shown and described herein;

FIG. 19 is a high resolution photograph of a welded article that was subjected to a full laser sweep of parallel lines over the face of the sample, according to one or more embodiments shown and described herein;

FIG. 20 is a high resolution photograph of another view of the welded article of FIG. 19;

FIG. 21 is a high resolution photograph of another view of the welded article of FIG. 19;

FIG. 22 is a photograph of a welded article that was subjected to a full laser sweep of parallel lines over the face of the article, with three regions identified that were analyzed by high resolution microscopy, according to one or more embodiments shown and described berein;

FIG. 23 is a high resolution microscope image of a region of the welded article of FIG. 22;

FIG. 24 is a high resolution microscope image of another region of the welded article of FIG. 22;

FIG. 25 is a high resolution microscope image of another region of the welded article of FIG. 22;

FIG. 26 is photograph of a welded article that was subjected to a full laser sweep of parallel lines over the face of the article, with two regions identified that were analyzed by high resolution microscopy, according to one or more embodiments shown and described herein;

FIG. 27 is a high resolution microscope image of a region of the welded article of FIG. 26; and

FIG. 28 is a high resolution microscope image of another region of the welded article of FIG. 26.

### DETAILED DESCRIPTION

Reference will now be made in detail to various embodiments of methods of laser bonding glass to metal foil such that the metal foil may be further processed (e.g., patterned) after welding. According to embodiments, a method of bonding glass to metal foil comprises contacting a glass substrate and a metal foil to create an interface therebetween; and directing a laser beam operating at a predetermined wavelength onto the interface to form an interfacial weld between the glass substrate and the metal foil, wherein the metal foil has a thickness greater than or equal to 5 μm and less than or equal to 200 μm, and wherein the laser beam comprises a pulsed laser having a pulse width greater than or equal to 1 nanosecond and less than or equal to 200 nanoseconds. According to other embodiments, a method of bonding glass to metal foil comprises contacting a glass substrate and a metal foil to create an interface therebetween; and directing a laser beam operating at a predetermined wavelength onto the interface to form an interfacial weld between the glass substrate and the metal foil, wherein the metal foil has a thickness greater than 100 nm and less than or equal to 10 mm, and wherein the laser beam comprises a pulsed laser having a pulse width greater than or equal to 1 nanosecond and less than or equal to 200 nanoseconds. Various embodiments of laser bonding glass to metal foil and the packages formed therefrom will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about.” it will be understood that the particular value forms another embodiment. It will be further understood that the endpoints of each of the ranges are significant both in relation to the other endpoint, and independently of the other endpoint.

Directional terms as used herein-for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps. operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Dark field microscope images, as described herein, are obtained using a TNP Instruments microscope.

“Hermetically bonded” or “hermetically sealed,” as described herein, refers to an article that includes a hermetic seal in accordance with MIL-STD-750E, Test Method 1071.8.

“Metal foil,” as described herein, refers to a film, sheet, shim, plate, or combination thereof having a thickness and one or more layers and formed by a metal or a metal alloy.

Hermetically welded glass articles may be used in devices which benefit from hermetic packaging, such as televisions, sensors, optical devices, organic light emitting diode (OLED) displays, 3D inkjet printers, solid-state lighting sources, batteries, and photo-voltaic structures. Conventional glass-to-glass laser bonding methods may use a thin metal film (e.g., less than or equal to 100 nm) as an absorbing layer to create heat such that the glass melts and bonds. However, the thin metal film may dissolve during such conventional methods and not be available for further processing after welding.

Disclosed herein are methods of laser bonding glass to metal foil which mitigate the aforementioned problems such that the metal foil may be further processed (e.g., patterned) after welding. Specifically, the methods of laser bonding glass to metal foil disclosed herein utilize a nanosecond pulsed laser to bond a glass substrate and a thick metal foil (e.g., metal foil with thickness greater than or equal to 5 μm or greater than 100 nm) to produce a welded article having a sufficient bond (e.g., surface energy bond strength greater than or equal to 0.2 J/m²) and a metal foil that may be further processed.

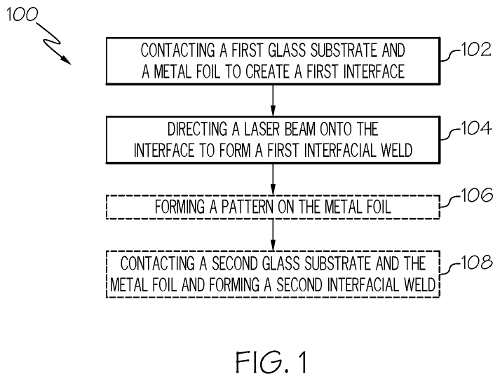

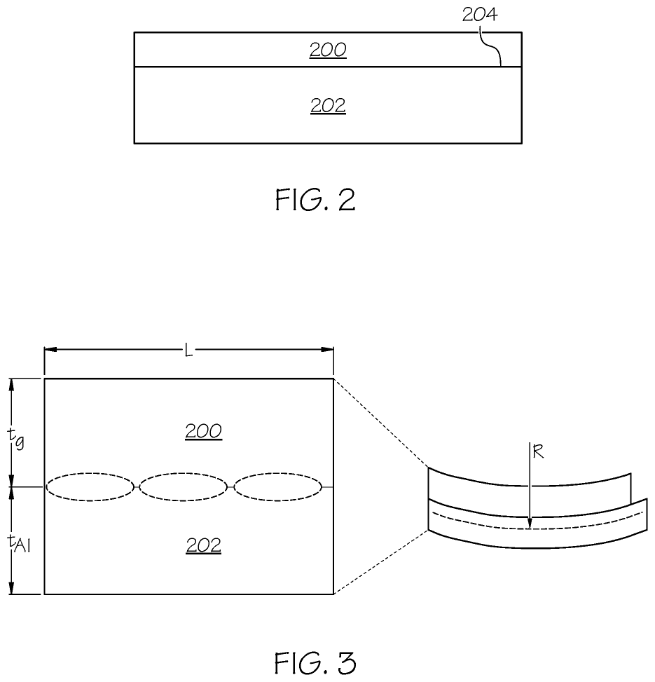

Referring now to FIG. 1, a method of laser bonding glass to metal foil 100 begins at block 102 with contacting a first glass substrate 200 and a metal foil 202 to create an interface 204 therebetween as shown in FIG. 2.

In embodiments, the first glass substrate 200 may comprise a glass or a glass-ceramic. By way of non-limiting examples, the first glass substrate may comprise silica, soda-lime silicate, aluminosilicate, alkali-aluminosilicate, borosilicate, alkali-borosilicate, aluminoborosilicate, and alkali-alumino-borosilicate, or alkali-aluminosilicate. In embodiments, the first glass substrate 200 may comprise an inorganic oxide.

In embodiments, the first glass substrate 200 may be formed from a material that is substantially transparent to a selected wavelength of a laser beam. The term “substantially transparent” means that a wavelength of a laser beam transmits through the material without being substantially absorbed or scattered. For example, in embodiments, a material that is substantially transparent to a wavelength of a laser beam may be a material that exhibits a transmittance greater or equal to 90% at the wavelength. In embodiments, the first glass substrate 200 may be substantially transparent to a wavelength of light greater than or equal to 300 nm and less than or equal to 1250 nm or even greater than or equal to 350 nm and less than or equal to 1000 nm.

In embodiments, the metal foil 202 may comprise aluminum, aluminum alloys. stainless steel, nickel, nickel alloys, silver, silver alloys, titanium, titanium alloys, tungsten, tungsten alloys, gold, gold alloys, copper, copper alloys, bronze, iron, or a combination thereof. In embodiments, the metal foil 202 may comprise aluminum or an aluminum alloy. As used herein. “aluminum” or “aluminum alloy” refers to a material that has greater than or equal to 80 wt % aluminum.

In embodiments, the metal foil 202 may be formed from a material that is substantially opaque to a selected wavelength of a laser beam. The term “substantially opaque” means that the wavelength of the laser beam is substantially absorbed when the laser beam contacts the material. For example, in embodiments, a material that is substantially opaque to a wavelength of a laser beam may be a material that exhibits an absorbance greater than or equal to 35% at the wavelength.

In embodiments, the thicknesses of the first glass substrate 200 and the metal foil 202 may be selected such that the interfacial weld therebetween may survive thermal cycling tests.

The metal foil 202 may have a higher thermal conductivity and a different coefficient of thermal expansion (CTE) than the first glass substrate 200, which may lead to warping and cracking during processing and use. Referring now to FIG. 3, a thermal stress mismatch induces interface elongation mismatch at an elevated temperature ΔT. This elongation mismatch introduces bowing or warpage, generating stress in the first glass substrate 200, with a characteristic effective radius R (to the neutral layer).

The thermal stress mismatch between the first glass substrate 200 and the metal foil 202, σ_{glass}−σₘₑₜₐₗ, may be calculated in accordance with the following formula:

$${σ}_{glass} - {σ}_{metal} \approx [ {E}_{glass} \cdot {CTE}_{glass} - {E}_{metal} \cdot {CTE}_{metal} ) \cdot Δ T \cdot L$$

where E_{glass} and CTE_{glass} are the Young's modulus and the CTE of the first glass substrate 200, Eₘₑₜₐₗ and CTEₘₑₜₐₗ are the Young's modulus and the CTE of the metal foil 202, ΔT is the elevated temperature, and L is the length of the first glass substrate 200. When the thermal stress mismatch σ_{glass}−σₘₑₜₐₗ exceeds the tensile strength of the first glass substrate 200, the first glass substrate will crack and/or break.

As shown by the following Stoney-type formula, the stress dependence of the first glass substrate 200, σ_{glass}, is roughly the square of the metal foil 202 thickness, tₘₑₜₐₗ:

$${σ}_{glass} = \frac{{E}_{metal} \cdot {t}_{metal}^{3}}{6 {Rt}_{glass} ( {t}_{metal} + {t}_{glass} )}$$

Accordingly, if the first glass substrate 200 is significantly thinner than the metal foil 202, then the resulting stress of the welded first glass substrate 200 and the metal foil 202 may be managed such that cracking and/or breakage is prevented.

The metal foil 202 is not brittle and has a relatively high CTE, and, thus, may be more accommodating of applied stress than the first glass substrate 200. Accordingly, in embodiments in which the metal foil 202 is thinner than the first glass substrate 200, a majority of stress may be located in the metal foil 202, which may prevent cracking and/or breakage.

Accordingly, in embodiments, the first glass substrate 200 may comprise a thickness greater than or equal to 0.1 mm, greater than or equal to 1 mm, greater than or equal to 10 mm, or even greater than or equal to 20 mm. In embodiments, the first glass substrate 200 may comprise a thickness less than or equal to 100 mm, less than or equal to 75 mm, or even less than or equal to 50 mm. In embodiments, the first glass substrate 200 may comprise a thickness greater than or equal to 0.1 mm and less than or equal to 100 mm, greater than or equal to 0.1 mm and less than or equal to 75 mm, greater than or equal to 0.1 mm and less than or equal to 50 mm, greater than or equal to 1 mm and less than or equal to 100 mm, greater than or equal to 1 mm and less than or equal to 75 mm, greater than or equal to 1 mm and less than or equal to 50 mm, greater than or equal to 10 mm and less than or equal to 100 mm, greater than or equal to 10 mm and less than or equal to 75 mm, greater than or equal to 10 mm and less than or equal to 50 mm, greater than or equal to 20 mm and less than or equal to 100 mm, greater than or equal to 20 mm and less than or equal to 75 mm, or even greater than or equal to 20 mm and less than or equal to 50 mm, or any and all sub-ranges formed from any of these endpoints.

In embodiments, the metal foil 202 may have a thickness greater than or equal to 5 μm such that the metal foil 202 may be further processed (e.g., patterned) after welding. In embodiments, the metal foil 202 may have a thickness less than or equal to 200 μm to minimize heat dispersion and reduce or prevent breakage during processing and use. In embodiments. the metal foil 202 may have a thickness greater than or equal to 5 μm and less than or equal to 200 μm. In embodiments, the metal foil 202 may have a thickness greater than or equal to 5 μm, greater than or equal to 10 μm, greater than or equal to 15 μm, or even greater than or equal to 20 μm. In embodiments, the metal foil 202 may have a thickness less than or equal to 200 μm, less than or equal to 150 μm, less than or equal to 100 μm, or even less than or equal to 50 μm. In embodiments, the metal foil 202 may have a thickness greater than or equal to 5 μm and less than or equal to 200 μm, greater than or equal to 5 μm and less than or equal to 150 μm, greater than or equal to 5 μm and less than or equal to 100 μm, greater than or equal to 5 μm and less than or equal to 50 μm, greater than or equal to 10 μm and less than or equal to 200 μm, greater than or equal to 10 μm and less than or equal to 150 μm, greater than or equal to 10 μm and less than or equal to 100 μm, greater than or equal to 10 μm and less than or equal to 50 μm, greater than or equal to 20 μm and less than or equal to 200 μm, greater than or equal to 20 μm and less than or equal to 150 μm, greater than or equal to 20 μm and less than or equal to 100 μm, or even greater than or equal to 20 μm and less than or equal to 50 μm, or any and all sub-ranges formed from any of these endpoints.

In embodiments, the metal foil 202 may have a thickness greater than 100 nm such that the metal foil 202 may be further processed (e.g., patterned) after welding. In embodiments, the metal foil 202 may have a thickness less than or equal to 10 mm to minimize heat dispersion and reduce or prevent breakage during processing and use. In embodiments, the metal foil 202 may have a thickness greater than 100 nm and less than or equal to 10 mm. In embodiments, the metal foil 202 may have a thickness greater than 100 nm, greater than or equal to 500 nm, greater than or equal to 0.001 mm, greater than or equal to 0.01 mm, or even greater than or equal to 0.1 mm. In embodiments, the metal foil 202 may have a thickness less than or equal to 10 mm, less than or equal to 5 mm, less than or equal to 1 mm, or even less than or equal to 0.5 mm. In embodiments, the metal foil 202 may have a thickness greater than 100 nm and less than or equal to 10 mm, greater than 100 nm and less than or equal to 5 mm, greater than 100 nm and less than or equal to 1 mm, greater than 100 nm and less than or equal to 0.5 mm, greater than or equal to 500 nm and less than or equal to 10 mm, greater than or equal to 500 nm and less than or equal to 5 mm, greater than or equal to 500 nm and less than or equal to 1 mm, greater than or equal to 500 nm and less than or equal to 0.5 mm, greater than or equal to 0.001 mm and less than or equal to 10 mm, greater than or equal to 0.001 mm and less than or equal to 5 mm, greater than or equal to 0.001 mm and less than or equal to 1 mm, greater than or equal to 0.001 mm and less than or equal to 0.5 mm, greater than or equal to 0.01 mm and less than or equal to 10 mm, greater than or equal to 0.01 mm and less than or equal to 5 mm, greater than or equal to 0.01 mm and less than or equal to 1 mm, greater than or equal to 0.01 mm and less than or equal to 0.5 mm, greater than or equal to 0.1 mm and less than or equal to 10 mm, greater than or equal to 0.1 mm and less than or equal to 5 mm, greater than or equal to 0.1 mm and less than or equal to 1 mm, or even greater than or equal to 0.1 mm and less than or equal to 0.5 mm, or any and all sub-ranges formed from any of these endpoints.

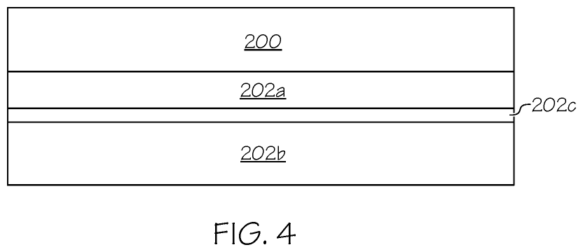

In embodiments, the metal foil 202 may comprise at least two layers. For example, referring now to FIG. 4, the metal foil may comprise a first metal layer 202a and a second metal layer 202b.

The first metal layer 202a is adjacent and bonded to the glass substrate 200. In embodiments, the first metal layer 202a may comprise an oxide of a metal with relatively high oxygen negativity or high enthalpy of oxide formation such that the first metal layer 202a has relatively good adhesion with glass substrate 200. For example, in embodiments, the first metal layer 202a may comprise aluminum, manganese, tantalum, chromium, cobalt, magnesium, iron, titanium, or a combination thereof.

In embodiments, the first metal layer 202a may have a thickness greater than or equal to 10 nm and less than or equal to 15 μm. In embodiments, the first metal layer 202a may have a thickness greater than or equal to 10 nm, greater than or equal to 50 nm greater than or equal to 100 nm, greater than or equal to 250 nm, greater than or equal to 500 nm, or even greater than or equal to 1 μm. In embodiments, the first metal layer 202a may have a thickness less than or equal to 15 μm, less than or equal to 10 μm, or even less than or equal to 5 μm. In embodiments, the first metal layer 202a may have a thickness greater than or equal to 10 nm and less than or equal to 15 μm, greater than or equal to 10 nm and less than or equal to 10 μm, greater than or equal to 10 nm and less than or equal to 5 μm, greater than or equal to 50 nm and less than or equal to 15 μm, greater than or equal to 50 nm and less than or equal to 10 μm, greater than or equal to 50 nm and less than or equal to 5 μm, greater than or equal to 100 nm and less than or equal to 15 μm, greater than or equal to 100 nm and less than or equal to 10 μm, greater than or equal to 100 nm and less than or equal to 5 μm, greater than or equal to 250 nm and less than or equal to 15 μm, greater than or equal to 250 nm and less than or equal to 10 μm, greater than or equal to 250 nm and less than or equal to 5 μm, greater than or equal to 500 nm and less than or equal to 15 μm, greater than or equal to 500 nm and less than or equal to 10 μm, greater than or equal to 500 om and less than or equal to 5 μm, greater than or equal to 1 μm and less than or equal to 15 μm, greater than or equal to 1 μm and less than or equal to 10 μm, or even greater than or equal to 1 μm and less than or equal to 5 82 m, or any and all sub-ranges formed from any of these endpoints.

In embodiments, the second metal layer 202b may comprise an oxide of a metal with a relatively low oxygen negativity such that the second metal layer 202b would have relatively poor adhesion with glass substrate 200. For example, in embodiments, the second metal layer 202b may comprise copper, silver, gold, molybdenum, titanium, aluminum, stainless steel. nickel, tungsten, bronze, iron, any alloy thereof, or a combination thereof. Accordingly, in embodiments, a second metal layer 202b may be bonded to a first metal layer 202a having relatively good adhesion with the glass substrate 200 in order to bond second metal layer 202b to glass substrate 200. The second metal layer 202b may then be further processed (e.g., patterned) after welding.

In embodiments, the second metal layer 202b may have a thickness greater than or equal to 100 μm and less than or equal to 10 mm. In embodiments, the second metal layer 202b may have a thickness greater than or equal to 100 nm, greater than or equal to 500 nm, greater than or equal to 0.001 mm, greater than or equal to 0.01 mm, or even greater than or equal to 0.1 mm. In embodiments, the second metal layer 202b may have a thickness less than or equal to 10 mm, less than or equal to 5 mm, less than or equal to 1 mm, or even less than or equal to 0.5 mm. In embodiments, the second materal layer 202b may have a thickness greater than or equal to 100 nm and less than or equal to 10 mm, greater than or equal to 100 nm and less than or equal to 5 mm, greater than or equal to 100 nm and less than or equal to 1 mm, greater than or equal to 100 nm and less than or equal to 0.5 mm, greater than or equal to 500 nm and less than or equal to 10 mm, greater than or equal to 500 nm and less than or equal to 5 mm, greater than or equal to 500 nm and less than or equal to 1 mm, greater than or equal to 500 nm and less than or equal to 0.5 mm, greater than or equal to 0.001 mm and less than or equal to 10 mm, greater than or equal to 0.001 mm and less than or equal to 5 mm, greater than or equal to 0.001 mm and less than or equal to 1 mm, greater than or equal to 0.001 mm and less than or equal to 0.5 mm, greater than or equal to 0.01 mm and less than or equal to 10 mm, greater than or equal to 0.01 mm and less than or equal to 5 mm, greater than or equal to 0.01 mm and less than or equal to 1 mm, greater than or equal to 0.01 mm and less than or equal to 0.5 mm, greater than or equal to 0.1 mm and less than or equal to 10 mm, greater than or equal to 0.1 mm and less than or equal to 5 mm, greater than or equal to 0.1 mm and less than or equal to 1 mm, or even greater than or equal to 0.1 mm and less than or equal to 0.5 mm, or any and all sub-ranges formed from any of these endpoints.

In embodiments, the metal foil may comprise a first metal adhesion layer 202c between the first metal layer 202a and the second metal layer 202b to assist in bonding the second metal layer 202b to the first metal layer 202a. In embodiments, the first metal adhesion layer 202c may comprise chromium, tungsten, tantalum, titanium, niobium, any alloy thereof. or a combination thereof.

In embodiments, the first metal adhesion layer 202c may have a thickness greater than or equal to 1 nm and less than or equal to 250 nm. In embodiments, the first metal adhesion layer 202c may have a thickness greater than or equal to 1 nm, greater than or equal to 10 nm, or even greater than or equal to 25 nm. In embodiments, the first metal adhesion layer 202c may have a thickness less than or equal to 250 nm, less than or equal to 200 nm, less than or equal to 150 nm, or even less than or equal to 100 nm. In embodiments, the first metal adhesion layer 202c may have a thickness greater than or equal to 1 nm and less than or equal to 250 nm, greater than or equal to 1 nm and less than or equal to 200 nm, greater than or equal to 1 nm and less than or equal to 150 nm, greater than or equal to 1 nm and less than or equal to 100 nm, greater than or equal to 10 nm and less than or equal to 250 nm, greater than or equal to 10 nm and less than or equal to 200 nm, greater than or equal to 10 nm and less than or equal to 150 nm, greater than or equal to 10 nm and less than or equal to 100 nm, greater than or equal to 25 nm and less than or equal to 250 nm, greater than or equal to 25 nm and less than or equal to 200 nm, greater than or equal to 25 nm and less than or equal to 150 nm, or even greater than or equal to 25 nm and less than or equal to 100 nm, or any and all sub-ranges formed from any of these endpoints.

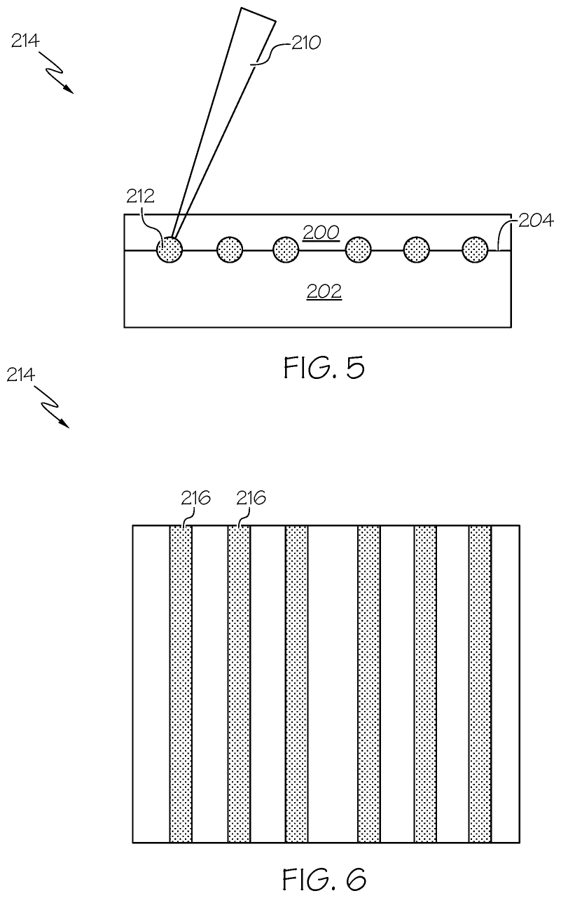

Referring back to FIG. 1 and now to FIGS. 5 and 6, the method 100 continues at block 104 with directing a laser beam 210 operating at a predetermined wavelength onto the interface 204 to form a first interfacial weld 212 between the first glass substrate 200 and the metal foil 202, resulting in a welded article 214.

In embodiments, the laser beam 210 may comprise a pulsed laser. In embodiments, the pulsed laser may be a nanosecond laser to form a relatively wider weld (e.g., weld lines having width greater than or equal to 5 μm), leading to increased processing speeds and a stronger bond. In embodiments, the pulsed laser may comprise a pulse width greater than or equal to 1 nanosecond and less than or equal to 200 nanoseconds. In embodiments, the pulsed laser may comprise a pulse width greater than or equal to 1 nanosecond, greater than or equal to 10 nanoseconds, or even greater than or equal to 25 nanosecond. In embodiments, the pulsed laser may comprise a pulsed width less than or equal to 200 nanoseconds, less than or equal to 150 nanoseconds, less than or equal to 100 nanoseconds, or even less than or equal to 50 nanoseconds. In embodiments, the pulsed laser may comprise a pulse width greater than or equal to 1 nanosecond and less than or equal to 200 nanoseconds, greater than or equal to 1 nanosecond and less than or equal to 150 nanoseconds, greater than or equal to 1 nanosecond and less than or equal to 100 nanoseconds, greater than or equal to 1 nanosecond and less than or equal to 50 nanoseconds, greater than or equal to 10 nanoseconds and less than or equal to 200 nanoseconds, greater than or equal to 10 nanoseconds and less than or equal to 150 nanoseconds, greater than or equal to 10 nanoseconds and less than or equal to 100 nanoseconds, greater than or equal to 10 nanosecond sand less than or equal to 50 nanoseconds, greater than or equal to 25 nanoseconds and less than or equal to 200 nanoseconds, greater than or equal to 25 nanoseconds and less than or equal to 150 nanoseconds, greater than or equal to 25 nanoseconds and less than or equal to 100 nanoseconds, or even greater than or equal to 25 nanoseconds and less than or equal to 50 nanoseconds, or any and all sub-ranges formed from any of these endpoints.

In embodiments, the pulsed laser may comprise a wavelength greater than or equal 260 nm and less than or equal to 2500 nm. In embodiments, the pulsed laser may comprise a wavelength greater than or equal 260 nm, greater than or equal to 300 nm, greater than or equal to 350 nm, greater than or equal to 400 nm, greater than or equal to 450 nm, or even greater than or equal to 500 nm. In embodiments, the pulsed laser may comprise a wavelength less than or equal to 2500 nm, less than or equal to 2000 nm, less than or equal to 1500 nm, less than or equal to 1250 nm, or even less than or equal to 1000 nm. In embodiments, the pulsed laser may comprise a wavelength greater than or equal to 260 nm and less than or equal to 2500 nm, greater than or equal to 260 nm and less than or equal to 2000 nm, greater than or equal to 260 nm and less than or equal to 1500 nm, greater than or equal to 260 nm and less than or equal to 1250 nm, greater than or equal to 260 nm and less than or equal to 1000 nm, greater than or equal to 300 nm and less than or equal to 2500 nm, greater than or equal to 300 nm and less than or equal to 2000 nm, greater than or equal to 300 nm and less than or equal to 1500 nm, greater than or equal to 300 nm and less than or equal to 1250 nm, greater than or equal to 300 nm and less than or equal to 1000 nm, greater than or equal to 350 nm and less than or equal to 2500 nm, greater than or equal to 350 nm and less than or equal to 2000 nm, greater than or equal to 350 nm and less than or equal to 1500 nm, greater than or equal to 350 nm and less than or equal to 1250 nm, greater than or equal to 350 nm and less than or equal to 1000 nm, greater than or equal to 400 nm and less than or equal to 2500 nm, greater than or equal to 400 nm and less than or equal to 2000 nm, greater than or equal to 400 nm and less than or equal to 1500 nm, greater than or equal to 400 nm and less than or equal to 1250 nm, greater than or equal to 400 nm and less than or equal to 1000 nm, greater than or equal to 450 nm and less than or equal to 2500 nm, greater than or equal to 450 nm and less than or equal to 2000 nm, greater than or equal to 450 nm and less than or equal to 1500 nm, greater than or equal to 450 nm and less than or equal to 1250 nm, greater than or equal to 450 nm and less than or equal to 1000 nm, greater than or equal to 500 nm and less than or equal to 2500 nm, greater than or equal to 500 nm and less than or equal to 2000 nm, greater than or equal to 500 nm and less than or equal to 1500 nm, greater than or equal to 500 nm and less than or equal to 1250 nm, or even greater than or equal to 500 nm and less than or equal to 1000 nm, or any and all sub-ranges formed from any of these endpoints.

In embodiments, the pulsed laser may comprise a repetition rate greater than or equal to 1 kHz and less than or equal to 1000 kHz. In embodiments, the pulsed laser may comprise a repetition rate greater than or equal to I kHz, greater than or equal to 10 kHz, or even greater than or equal to 25 kHz. In embodiments, the pulsed laser may comprise a repetition rate less than or equal to 1000 kHz, less than or equal to 750 kHz, less than or equal to 500 kHz, less than or equal to 250 kHz, less than or equal to 100 kHz, or even less than or equal to 50 kHz. In embodiments, the pulsed laser may comprise a repetition rate greater than or equal to 1 kHz and less than or equal to 1000 kHz, greater than or equal to 1 kHz and less than or equal to 750 kHz, greater than or equal to 1 kHz and less than or equal to 500 kHz, greater than or equal to 1 kHz and less than or equal to 250 kHz, greater than or equal to 1 kHz and less than or equal to 100 kHz, greater than or equal to 1 kHz and less than or equal to 50 kHz, greater than or equal to 10 KHz and less than or equal to 1000 kHz, greater than or equal to 10 KHz and less than or equal to 750 kHz, greater than or equal to 10 KHz and less than or equal to 500 KHz, greater than or equal to 10 KHz and less than or equal to 250 kHz, greater than or equal to 10 kHz and less than or equal to 100 kHz, greater than or equal to 10 kHz and less than or equal to 50 kHz, greater than or equal to 25 kHz and less than or equal to 1000 kHz, greater than or equal to 25 kHz and less than or equal to 750 kHz, greater than or equal to 25 KHz and less than or equal to 500 kHz, greater than or equal to 25 kHz and less than or equal to 250 kHz, greater than or equal to 25 kHz and less than or equal to 100 kHz, or even greater than or equal to 25 kHz and less than or equal to 50 kHz, or any and all sub-ranges formed from any of these endpoints.

In embodiments, the pulsed laser may comprise an energy density greater than or equal to 0.1 J/cm² and less than or equal to 100 J/cm². In embodiments, the pulsed laser may comprise an energy density greater than or equal to 0.1 J/cm², greater than or equal to 1 J/cm², greater than or equal to 5 J/cm², or even greater than or equal to 10 J/cm², or even greater than or equal to 25 J/cm². In embodiments, the pulsed laser may comprise an energy density less than or equal to 100 J/cm², less than or equal to 75 J/cm², or even less than or equal to 50 J/cm². In embodiments, the pulsed laser may comprise an energy density greater than or equal to 0.1 J/cm² and less than or equal to 100 J/cm², greater than or equal to 0.1 J/cm² and less than or equal to 75 J/cm², greater than or equal to 0.1 J/cm² and less than or equal to 50 J/cm², greater than or equal to 1 J/cm² and less than or equal to 100 J/cm², greater than or equal to 1 J/cm² and less than or equal to 75 J/cm², greater than or equal to 1 J/cm² and less than or equal to 50 J/cm², greater than or equal to 5 J/cm² and less than or equal to 100 J/cm², greater than or equal to 5 J/cm² and less than or equal to 75 J/cm², greater than or equal to 5 J/cm² and less than or equal to 50 J/cm², greater than or equal to 10 J/cm² and less than or equal to 100 J/cm², greater than or equal to 10 J/cm² and less than or equal to 75 J/cm², greater than or equal to 10 J/cm² and less than or equal to 50 J/cm², greater than or equal to 25 J/cm² and less than or equal to 100 J/cm², greater than or equal to 25 J/cm² and less than or equal to 75 J/cm², or even greater than or equal to 25 J/cm² and less than or equal to 50 J/cm², or any and all sub-ranges formed from any of these endpoints.

In embodiments, the pulsed laser may comprise a peak power density greater than or equal to 0.005 GW/cm² and less than or equal to 10 GW/cm². In embodiments, the pulsed laser may comprise a peak power density greater than or equal to 0.005 GW/cm², greater than or equal to 0.05 GW/cm², greater than or equal to 0.5 GW/cm², or even greater than or equal to 1 GW/cm². In embodiments, the pulsed laser may comprise a peak power density less than or equal to 10 GW/cm², less than or equal to 7 GW/cm², less than or equal to 5 GW/cm², or even less than or equal to 3 GW/cm². In embodiments, the pulsed laser may comprise a peak power density greater than or equal to 0.005 GW/cm² and less than or equal to 10 GW/cm², greater than or equal to 0.005 GW/cm² and less than or equal to 7 GW/cm², greater than or equal to 0.005 GW/cm² and less than or equal to 5 GW/cm², greater than or equal to 0.005 GW/cm² and less than or equal to 3 GW/cm², greater than or equal to 0.05 GW/cm² and less than or equal to 10 GW/cm², greater than or equal to 0.05 GW/cm² and less than or equal to 7 GW/cm², greater than or equal to 0.05 GW/cm² and less than or equal to 5 GW/cm², greater than or equal to 0.05 GW/cm² and less than or equal to 3 GW/cm², greater than or equal to 0.5 GW/cm² and less than or equal to 10 GW/cm², greater than or equal to 0.5 GW/cm² and less than or equal to 7 GW/cm², greater than or equal to 0.5 GW/cm² and less than or equal to 5 GW/cm², greater than or equal to 0.5 GW/cm² and less than or equal to 3 GW/cm², greater than or equal to 1 GW/cm² and less than or equal to 10 GW/cm², greater than or equal to 1 GW/cm² and less than or equal to 7 GW/cm², greater than or equal to 1 GW/cm² and less than or equal to 5 GW/cm², or even greater than or equal to 1 GW/cm² and less than or equal to 3 GW/cm², or any and all sub-ranges formed from any of these endpoints.

In embodiments, the pulsed laser may comprise a peak power greater than or equal to 50 W and less than or equal to 10 KW. In embodiments, the pulsed laser may comprise a peak power greater than or equal to 50 W, greater than or equal to 100 W, or even greater than or equal to 500 W. In embodiments, the pulsed laser may comprise a peak power less than or equal to 10 KW, less than or equal to 5 kW, or even less than or equal to 1 kW. In embodiments, the pulsed laser may comprise a peak power greater than or equal to 50 W and less than or equal to 10 kW, greater than or equal to 50 W and less than or equal to 5 KW, greater than or equal to 50 W and less than or equal to 1 kW, greater than or equal to 100 W and less than or equal to 10 KW, greater than or equal to 100 W and less than or equal to 5 kW, greater than or equal to 100 W and less than or equal to 1 kW, greater than or equal to 500 W and less than or equal to 10 KW, greater than or equal to 500 W and less than or equal to 5 KW, or even greater than or equal to 500 W and less than or equal to 1 KW, or any and all sub-ranges formed from any of these endpoints.

In embodiments, the pulsed laser may comprise an average power greater than or equal to 0.5 W and less than or equal to 5 W at 30 KHz repetition rate. In embodiments, the pulsed laser may comprise an average power greater than or equal to 0.5 W, greater than or equal to I W, or even greater than or equal to 2 W at 30 kHz repetition rate. In embodiments, the pulsed laser may comprise an average power less than or equal to 5 W, less than or equal to 4 W, or even less than or equal to 3 W at 30 KHz repetition rate. In embodiments, the pulsed laser may comprise an average power greater than or equal to 0.5 W and less than or equal to 5 W, greater than or equal to 0.5 W and less than or equal to 4 W, greater than or equal to 0.5 W and less than or equal to 3 W, greater than or equal to 1 W and less than or equal to 5 W, greater than or equal to 1 W and less than or equal to 4 W, greater than or equal to 1 W and less than or equal to 3 W, greater than or equal to 2 W and less than or equal to 5 W, greater than or equal to 2 W and less than or equal to 4 W, or even greater than or equal to 2 W and less than or equal to 3 W, or any and all sub-ranges formed from any of these endpoints, at 30 kHz repetition rate.

In embodiments, the first interfacial weld 212 may be a hermetic seal between the first glass substrate 200 and the metal foil 202. In embodiments, the first interfacial weld 212 may comprise weld lines 216. In embodiments, the weld lines 216 may have a width greater than or equal to 5 μm, which may help increase processing speeds and lead to a stronger bond. In embodiments, weld line width may be limited (e.g., less than or equal to 1 mm) to minimize heat dispersion and reduce or prevent breakage during processing and use. In embodiments. the weld lines 216 may have a width greater than or equal to 5 μm and less than or equal to 1 mm. In embodiments, the weld lines 216 may have a width greater than or equal to 5 μm, greater than or equal to 15 μm, or even greater than or equal to 25 μm. In embodiments, the weld lines 216 may have a width less than or equal to 1 mm, less than or equal to 750 μm, less than or equal to 500 μm, less than or equal to 250 μm, or even less than or equal to 100 μm. In embodiments, the weld lines 216 may have a width greater than or equal to 5 μm and less than or equal to 1 mm, greater than or equal to 5 μm and less than or equal to 750 μm, greater than or equal to 5 μm and less than or equal to 500 μm, greater than or equal to 5 μm and less than or equal to 250 μm, greater than or equal to 5 μm and less than or equal to 100 μm, greater than or equal to 15 μm and less than or equal to 1 mm, greater than or equal to 15 μm and less than or equal to 750 μm, greater than or equal to 15 μm and less than or equal to 500 μm, greater than or equal to 15 μm and less than or equal to 250 μm, greater than or equal to 15 μm and less than or equal to 100 μm, greater than or equal to 25 μm and less than or equal to 1 mm, greater than or equal to 25 μm and less than or equal to 750 μm, greater than or equal to 25 μm and less than or equal to 500 μm, greater than or equal to 25 μm and less than or equal to 250 μm, or even greater than or equal to 25 μm and less than or equal to 100 μm, or any and all sub-ranges formed from any of these endpoints.

In embodiments, a distance between weld lines 216 may be greater than or equal to 1 μm and less than or equal to 1000 μm. In embodiments, a distance between weld lines 216 may be greater than or equal to 1 μm, greater than or equal to 10 μm, greater than or equal to 25 μm, or even greater than or equal to 50 μm. In embodiments, a distance between weld lines 216 may be less than or equal to 1000 μm, less than or equal to 750 μm, less than or equal to 500 μm, less than or equal to 250 μm, or even less than or equal to 100 μm. In embodiments, a distance between weld lines 216 may be greater than or equal to 1 μm and less than or equal to 1000 μm, greater than or equal to 1 μm and less than or equal to 750 μm, greater than or equal to 1 μm and less than or equal to 500 μm, greater than or equal to 1 μm and less than or equal to 250 μm, greater than or equal to 1 μm and less than or equal to 100 μm, greater than or equal to 10 μm and less than or equal to 1000 μm, greater than or equal to 10 μm and less than or equal to 750 μm, greater than or equal to 10 μm and less than or equal to 500 μm, greater than or equal to 10 μm and less than or equal to 250 μm, greater than or equal to 10 m and less than or equal to 100 μm, greater than or equal to 25 μm and less than or equal to 1000 μm, greater than or equal to 25 μm and less than or equal to 750 μm, greater than or equal to 25 μm and less than or equal to 500 μm, greater than or equal to 25 μm and less than or equal to 250 μm, greater than or equal to 25 μm and less than or equal to 100 μm, greater than or equal to 50 μm and less than or equal to 1000 μm, greater than or equal to 50 μm and less than or equal to 750 μm, greater than or equal to 50 μm and less than or equal to 500 μm, greater than or equal to 50 μm and less than or equal to 250 μm, or even greater than or equal to 50 μm and less than or equal to 100 μm, or any and all sub-ranges formed from any of these endpoints In embodiments, the weld lines 216 may be evenly spaced apart (i.e., have a same distance between them) or unevenly spaced apart (i.e., have a different distance between them).

In embodiments, the metal foil 202 may be stretched out or thinned as a result of welding. In embodiments, the metal foil 202 of the welded article 214 has a thickness greater than or equal to 5 μm to allow for any subsequent processing. In embodiments, the metal foil 202 of the welded article 214 may have a thickness greater than or equal to 5 μm and less than or equal to 200 μm. In embodiments, the metal foil 202 of the welded article 214 may have a thickness greater than or equal to 5 μm, greater than or equal to 10 μm, greater than or equal to 15 μm, or even greater than or equal to 20 μm. In embodiments, the metal foil 202 of the welded article 214 may have a thickness less than or equal to 200 μm, less than or equal to 150 μm, less than or equal to 100 μm, or even less than or equal to 50 μm. In embodiments, the metal foil 202 of the welded article 214 may have a thickness greater than or equal to 5 μm and less than or equal to 200 μm, greater than or equal to 5 μm and less than or equal to 150 μm, greater than or equal to 5 μm and less than or equal to 100 μm, greater than or equal to 5 μm and less than or equal to 50 μm, greater than or equal to 10 μm and less than or equal to 200 μm, greater than or equal to 10 μm and less than or equal to 150 μm, greater than or equal to 10 μm and less than or equal to 100 μm, greater than or equal to 10 μm and less than or equal to 50 μm, greater than or equal to 20 μm and less than or equal to 200 μm, greater than or equal to 20 μm and less than or equal to 150 μm, greater than or equal to 20 μm and less than or equal to 100 μm, or even greater than or equal to 20 μm and less than or equal to 50 μm, or any and all sub-ranges formed from any of these endpoints.

In embodiments, the metal foil 202 of the welded article 214 may have a thickness greater than 100 nm and less than or equal to 10 mm. In embodiments, the metal foil 202 of the welded article 214 may have a thickness greater than 100 nm, greater than or equal to 500 nm, greater than or equal to 0.001 mm, greater than or equal to 0.01 mm, or even greater than or equal to 0.1 mm. In embodiments, the metal foil 202 of the welded article 214 may have a thickness less than or equal to 10 mm, less than or equal to 5 mm, less than or equal to 1 mm, or even less than or equal to 0.5 mm. In embodiments, the metal foil 202 of the welded article 214 may have a thickness greater than 100 nm and less than or equal to 10 mm, greater than 100 nm and less than or equal to 5 mm, greater than 100 nm and less than or equal to 1 mm, greater than 100 nm and less than or equal to 0.5 mm, greater than or equal to 500 nm and less than or equal to 10 mm, greater than or equal to 500 nm and less than or equal to 5 mm, greater than or equal to 500 nm and less than or equal to 1 mm, greater than or equal to 500 nm and less than or equal to 0.5 mm, greater than or equal to 0.001 mm and less than or equal to 10 mm, greater than or equal to 0.001 mm and less than or equal to 5 mm, greater than or equal to 0.001 mm and less than or equal to 1 mm, greater than or equal to 0.001 mm and less than or equal to 0.5 mm, greater than or equal to 0.01 mm and less than or equal to 10 mm, greater than or equal to 0.01 mm and less than or equal to 5 mm, greater than or equal to 0.01 mm and less than or equal to 1 mm, greater than or equal to 0.01 mm and less than or equal to 0.5 mm, greater than or equal to 0.1 mm and less than or equal to 10 mm, greater than or equal to 0.1 mm and less than or equal to 5 mm, greater than or equal to 0.1 mm and less than or equal to 1 mm, or even greater than or equal to 0.1 mm and less than or equal to 0.5 mm, or any and all sub-ranges formed from any of these endpoints.

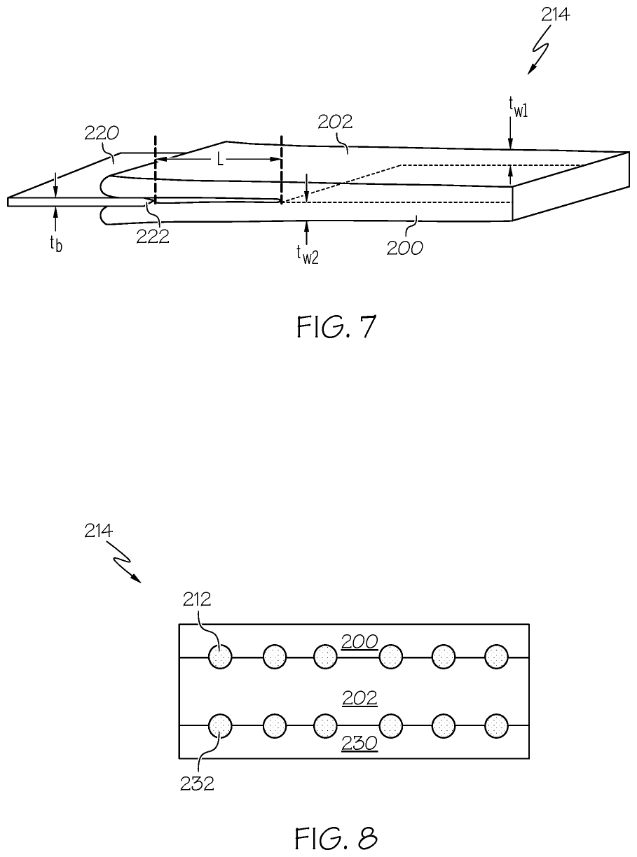

Referring now to FIG. 7, a surface energy bond strength of the welded article 214 may be determined according to a “razor blade test.” In particular, a razor blade 220 with a known thickness is inserted between the metal foil 202 and the first glass substrate 200, with known fracture mechanic material properties of the welded article 214 until crack formation occurs. The resulting crack length L from the razor blade edge 222 to the remaining sealed portion is used to calculate the surface energy bond strength γ using the following formula:

$$γ = \frac{( {γ}_{1} + {γ}_{2} )}{2} = \frac{3 \cdot {t}_{b}^{2} \cdot {E}_{1} \cdot {t}_{w 1}^{3} \cdot {E}_{2} \cdot {t}_{w 2}^{3}}{16 \cdot {L}^{4} \cdot ( {E}_{1} \cdot {t}_{w 1}^{3} + {E}_{2} \cdot {t}_{w 2}^{3} )}$$

where t_{b} is the thickness of the razor blade 220. L is the crack length. E₁ is the Young's modulus of the first glass substrate 200, E₂ is the Young's modulus of the metal foil 202, T_{w1} is the thickness of the first glass substrate 200, and T_{w2} is the thickness of the metal foil 202.

In embodiments, the first interfacial weld 212 sufficiently bonds the first glass substrate 200 and the metal foil 202 such that the welded article has a surface energy bond strength greater than or equal to 0.2 J/m². In embodiments, the welded article 214 has a surface energy bond strength greater than or equal to 0.2 J/m² and less than or equal to 3.0 J/m². In embodiments, the welded article 214 has a surface energy bond strength greater than or equal to 0.2 J/m², greater than or equal to 0.5 J/cm², greater than or equal to 0.8 J/m², greater than or equal to 1.0 J/m², greater than or equal to 1.2 J/m², or even greater than or equal to 1.5 J/m². In embodiments, the welded article 214 has a surface energy bond strength less than or equal to 3.0 J/m², less than or equal to 2.5 J/m², or even less than or equal to 2.0 J/m². In embodiments, the welded article 214 has a surface energy bond strength greater than or equal to 0.2 J/m² and less than or equal to 3.0 J/m², greater than or equal to 0.2 J/m² and less than or equal to 2.5 J/m², greater than or equal to 0.2 J/m² and less than or equal to 2.0 J/m², greater than or equal to 0.5 J/m² and less than or equal to 3.0 J/m², greater than or equal to 0.5 J/cm² and less than or equal to 2.5 J/m², greater than or equal to 0.5 J/m² and less than or equal to 2.0 J/m², greater than or equal to 0.8 J/m² and less than or equal to 3.0 J/m², greater than or equal to 0.8 J/m² and less than or equal to 2.5 J/m², greater than or equal to 0.8 J/m² and less than or equal to 2.0 J/m², greater than or equal to 1.0 J/m² and less than or equal to 3.0 J/m², greater than or equal to 1.0 J/m² and less than or equal to 2.5 J/m², greater than or equal to 1.0 J/m² and less than or equal to 2.0 J/m², greater than or equal to 1.2 J/m² and less than or equal to 3.0 J/m², greater than or equal to 1.2 J/m² and less than or equal to 2.5 J/m², greater than or equal to 1.2 J/m² and less than or equal to 2.0 J/m², greater than or equal to 1.5 J/m² and less than or equal to 3.0 J/m², greater than or equal to 1.5 J/m² and less than or equal to 2.5 J/m², or even greater than or equal to 1.5 J/m² and less than or equal to 2.0 J/m², or any and all sub-ranges formed from any of these endpoints.

Surface energy bond strength may be improved by a reduction in residual stress. which might otherwise result in cohesive failure. Less residual stress may be achieved by using less energy to weld and/or altering the thicknesses of the first glass substrate 200 and the metal foil 202. As described herein, “residual stress” is measured using birefringence. In particular, a 1 mm sample of a first glass substrate 200 and a metal foil 202 may be welded and cut (e.g., with a diamond cut saw). The resulting cross section is mounted in a polarimeter to measure the optical birefringence resulting from local stress regions. The birefringence is converted into residual stress using the known stress optic coefficient of the first glass substrate 200. In embodiments, the welded article 214 may have a residual stress less than or equal to 30 MPa. less than or equal to 25 MPa, less than or equal to 20 MPa, less than or equal to 15 MPa, or even less than or equal to 10 MPa. In embodiments, the welded article 214 may have a residual stress less than or equal to 50 MPa, less than or equal to 45 MPa, less than or equal to 40 MPa, less than or equal to 35 MPa, less than or equal to 30 MPa, less than or equal to 25 MPa, less than or equal to 20 MPa, less than or equal to 15 MPa, or even less than or equal to 10 MPa.

Referring back to FIG. 1, the method 100 may optionally continue at block 106 with forming a pattern on the metal foil 202 of the welded article 214 to form a patterned metal foil. As described herein, the thickness of the metal foil 202 of the welded article 214 is such to allow for subsequent processing after welding. In embodiments, the metal foil 202 of the welded article 214 may be subjected to patterning, soldering, brazing, or electroplating.

Referring back to FIG. 1 and FIG. 8, the method 100 may optionally continue at block 108 with contacting a second glass substrate 230 to the metal foil and forming a second interfacial weld 232 between the second glass substrate 230 and the metal foil 202. In embodiments, the second glass substrate 230 may have the same or different composition and properties as the first glass substrate 200 as described hereinabove. In embodiments, the laser beam used to form the second interfacial weld 232 may have the same or different properties as the laser beam used to form the first interfacial weld 212 as described hereinabove. In embodiments, the second interfacial weld 232 may have the same or different properties as the first interfacial weld 212 as described hereinabove. In embodiments, the metal foil 202 may be subsequently processed as described hereinabove after the formation of the second interfacial weld 232.

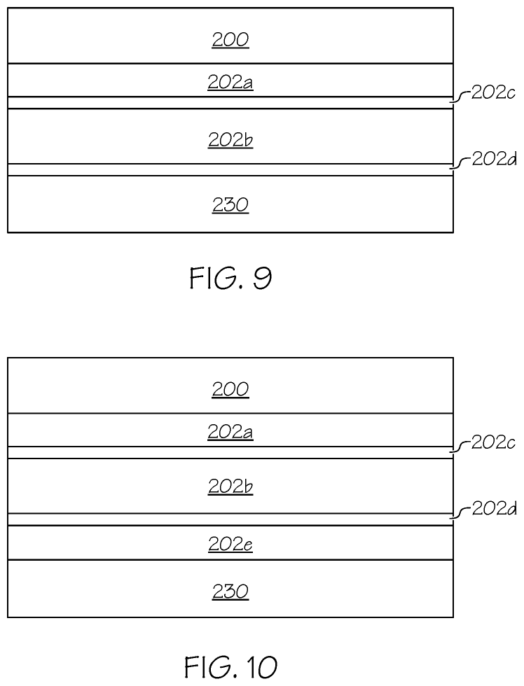

For example, referring now to FIG. 9, the metal foil may comprise first metal layer 202a, second metal layer 202b, and optionally first metal adhesion layer 202c. The metal foil may further comprise a second metal adhesion layer 202d adjacent to and bonding the second metal layer 202b to the second glass substrate 230. In embodiments, the second metal adhesion layer 202d may have the same or different properties as the first metal adhesion layer 202c as described hereinabove.

Referring now to FIG. 10, the metal foil may further comprise a third metal layer 202e adjacent to and contacting the second metal adhesion layer 202d and the second glass substrate 230. In embodiments, the third metal layer 202e may have the same or different properties as the first metal layer 202a.

### EXAMPLES

In order that various embodiments be more readily understood, reference is made to the following examples, which illustrate various embodiments of the laser bonding methods described herein.

### Example 1—Weld Lines

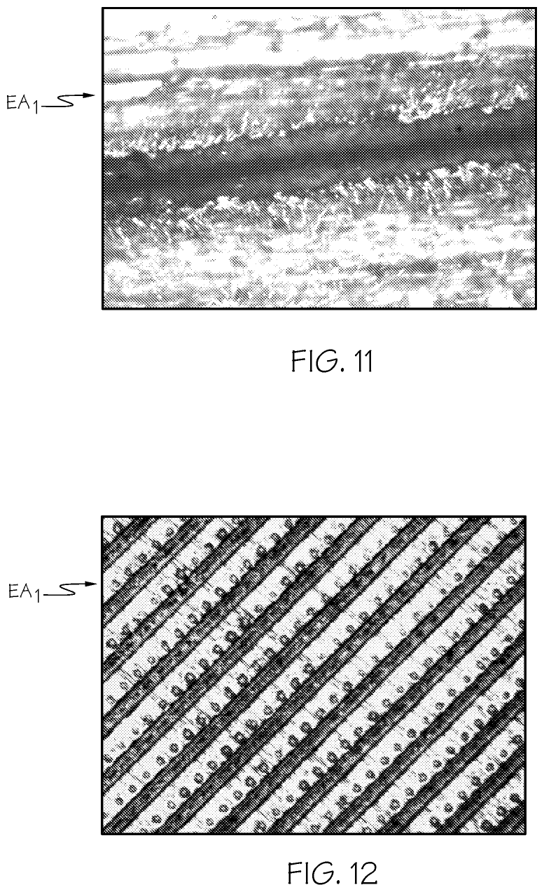

Referring now to FIGS. 11 and 12, a 6 μm thick piece of aluminum foil was pressed against a 0.4 mm EAGLE XG® (alkaline earth boro-aluminosilicate) glass substrate. The focal region (spot diameter≈40 μm) of a pulsed laser (Spectra Physics Hippo; wavelength=355 nm; repetition rate=30 kHz) having an 8 nanosecond pulse width was swept along the aluminum foil glass substrate interface at a rate of 100 mm/sec to produce example welded article EA₁. The incident average power of the laser was 2.5 W and the peak power of the laser was 0.8 GW/cm².

As shown in FIG. 12, the weld lines of example welded article EA₁ were approximately 50 μm, with a distance of 100 μm between weld lines. As indicated by FIGS. 11 and 12, the method of bonding glass to metal foil using the metal foil thickness and laser beam properties described herein result in weld lines having a width that is large enough to increase processing speeds, but small enough to minimize heat dispersion and reduce or prevent breakage during processing and use.

### Example 2—Bond Strength

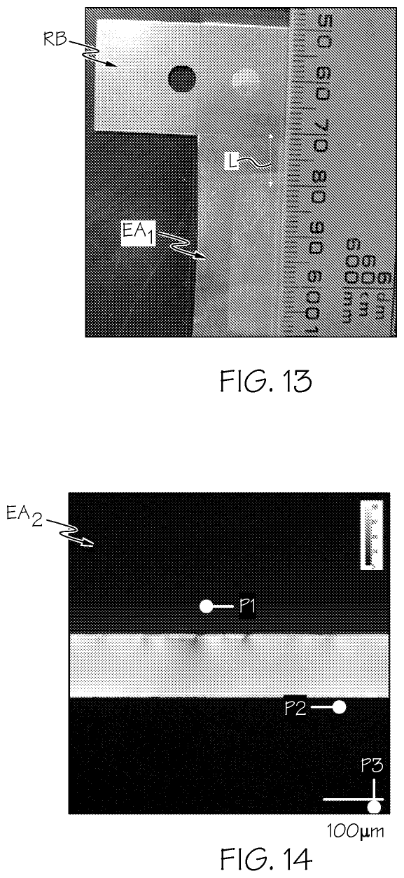

Referring now to FIG. 13, example welded article EA₁, was subjected to a “razor blade test” as described herein, with razor blade RB and crack length L shown. Referring now to Table 1, the parameters used are shown to result in a bond strength of ˜1.9 J/m², which is relatively strong for glass-metal bonds and similarly strong to glass-to-glass bonds.

TABLE 1

| | | |
|---|---|---|
| t_{b} | 0.14 | mm |
| L | 9.80 | μm |
| E₁ | 73.6 | GPa |
| E₂ | 68.0 | GPa |
| T_{w1} | 0.40 | mm |
| T_{w2} | 6.00 | mm |

### Example 3—Residual Stress

A 6 μm thick piece of aluminum foil was pressed between two a 0.4 mm EAGLE XG® (alkaline earth boro-aluminosilicate) glass substrates. The focal region (spot diameter≈60 μm) of a pulsed laser (Spectra Physics Hippo; wavelength=355 nm; repetition rate=30 kHz) having a nanosecond pulse width was swept along the aluminum foil glass substrate interfaces at a rate of 100 mm/sec to produce example welded article EA₂. The incident average power of the laser was 2.3 W and the peak power of the laser was 0.45 GW/cm².

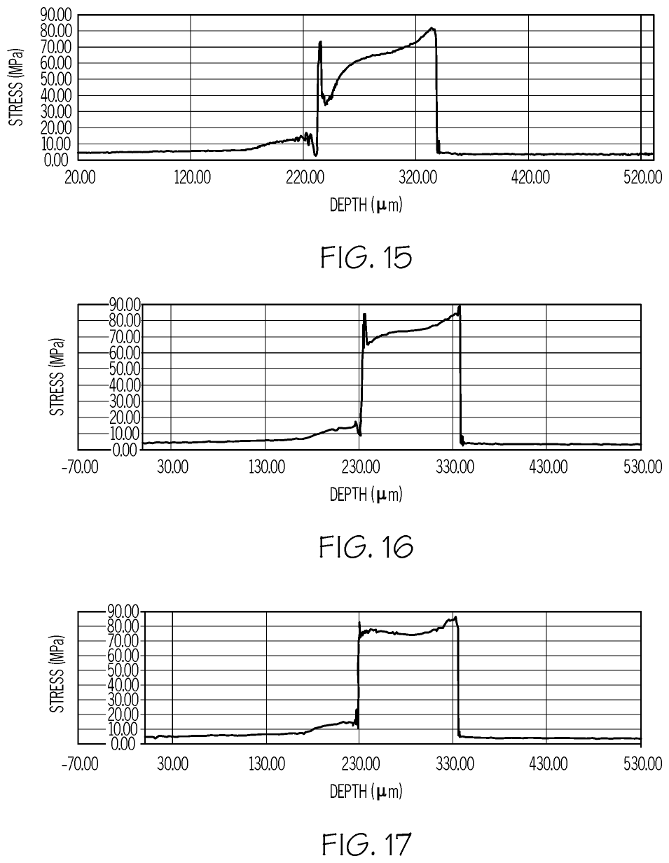

Referring now to FIG. 14, example welded article EA₂, having a 1 mm thickness, was cut and mounted in a polarimeter to measure the optical birefringence resulting from local stress regions. The birefringence at three points P1, P2, and P3 in the glass substrates was converted into residual stress using the known stress optic coefficient of EAGLE XG® and plotted as a function of depth as shown in FIGS. 15, 16, and 17, respectively.

As shown in FIGS. 15, 16, and 17, there was substantially low stress (i.e., less than or equal to 5 MPa) on either side of the large middle protuberance at each of the three points. The substantially low stress regions indicate the low glass residual stress after welding. Note that the large middle protuberance is an artifact of the metal foil.

### Example 4—Multi-Layer Metal Foil and Laser Bonding Conditions

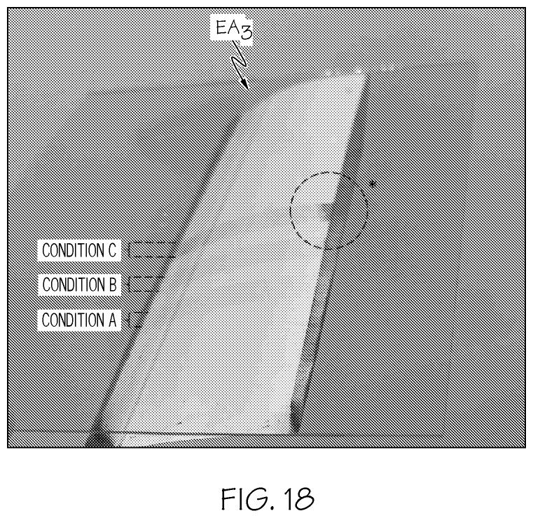

Referring now to FIG. 18, a 263 μm thick copper shim having a 50 nm thick chromium adhesion layer was adhered to a 2.1 μm thick piece of aluminum foil. The multi-layer metal foil was pressed against a 0.7 mm EAGLE XG® (alkaline earth boro-aluminosilicate) glass substrate. The resulting structure was subjected to Conditions A, B, and C to test three different laser bonding conditions. In each of these conditions, the focal region (spot diameter of about 100 μm) of a pulsed laser having a wavelength of 355 nm was swept along a lincar path and directed through the glass substrate to the interface between the glass substrate and the aluminum foil. The specifics of Conditions A, B, and C is shown in Table 2.

TABLE 2

| | | | | | | Number | | |
|---|---|---|---|---|---|---|---|---|
| | | | | | | of Shots | | Distance |
| | | Sweep | Pulse | Spot | Dwell | per Unit | Pulse | Between |
| | Fluence | Velocity | Rate | Area | Time | Dwell | Energy | Pulses |
| Condition | (J/cm²) | (mm/s) | (kHz) | (cm²) | (s) | Time | (μJ) | (μm) |
| A | 0.87 | 50 | 5 | 0.00018 | 0.003 | 15 | 154 | 10 |
| B | 1.07 | 50 | 10 | 0.00018 | 0.003 | 15 | 190 | 10 |
| C | 1.13 | 10 | 30 | 0.00018 | 0.015 | 450 | 200 | 0.33 |

The results are shown in FIG. 18, which is a view through the glass substrate of example welded article EA₃. Condition A had no bonding. Condition B had fain, real ablation observed in spots. Condition C had a portion that was successfully welded, as indicated by the dashed circle in FIG. 18. Note that no special precautions were taken to optimize weld formation, such as polishing the glass substrate to atomic flatness or ensuring maximum contact between the glass substrate chromium adhesion layer. As a result, if steps are taken to ensure maximum contact during the laser bonding, a greater extent of welding across more of the attempted weld lines are expected, particularly under Condition C.

To confirm the validity of having attained suitable laser bonding conditions (i.e., Condition C with 1.13 J/cm² laser fluence), example welded article EA₃ was subjected to a full laser sweep of parallel lines over the face of the sample, which parallel lines are perpendicular to the original weld lines of Conditions A-C. The results are shown in FIGS. 19-21, in which the same sample has been photographed from multiple perspectives. Note that the laser bonded regions appear as dark lines, as indicated by the dashed line in FIG. 19 (view through the glass substrate). Flipping the sample of FIG. 19 results in FIG. 20 (bottom view of the sample), which shows a small unbonded portion towards the bottom right. FIG. 21 is an isometric perspective of the sample illustrating the tight and flattened copper shim that was originally semi-circularly bent. The copper shim was strongly bonded to the glass substrate via chromium adhesion layer, which is apparent by sweeping a finger and gently pulling on the rim of the welded article.

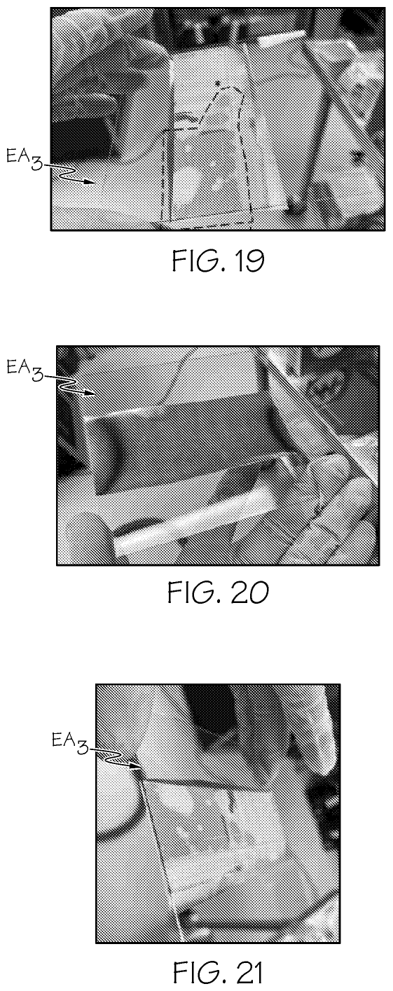

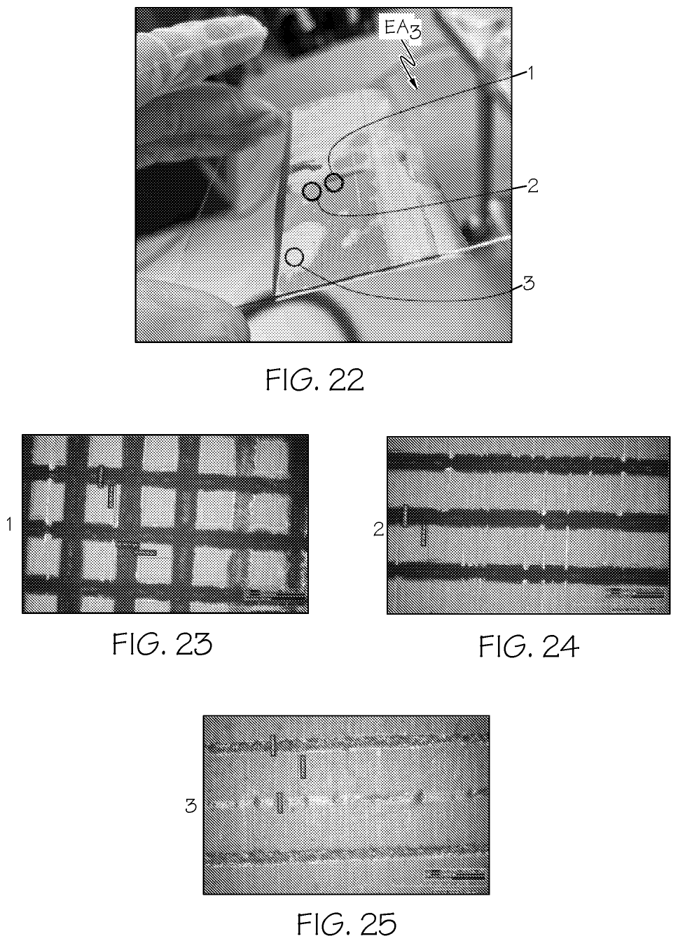

High resolution microscope images were obtain of three regions of example welded article EA₃, as depicted in FIG. 22, which reveals a larger spatial extent of the good bonding regions compared with the poor or non-bonding regions. FIGS. 23-25 show high resolution microscopy images obtained for regions 1, 2, and 3 in FIG. 22. Region 1, which corresponds to FIG. 23, had two laser sweeps that were conducted orthogonal to one another in a crisscross pattern. The weld line width in this area was about 106 μm to about 112 μm. This region was close to a non-bonding region, which manifests as poorer bonding considering the fainter weld lines toward the right of the image. Region 2, which corresponds to FIG. 24, was another good bonding section showing similar weld line widths. Note that this region exhibited well-bonded weld lines over an area where previous unsuccessful laser sweeps were performed. Region 3, which corresponds to FIG. 25, was a non-bonding region having attempted weld lines with much smaller spatial extent compared with the good bonding regions. Note that the measured attempted weld widths were about 41 μm to about 57 μm, far smaller than the about 100 μm width of the good bonding regions.

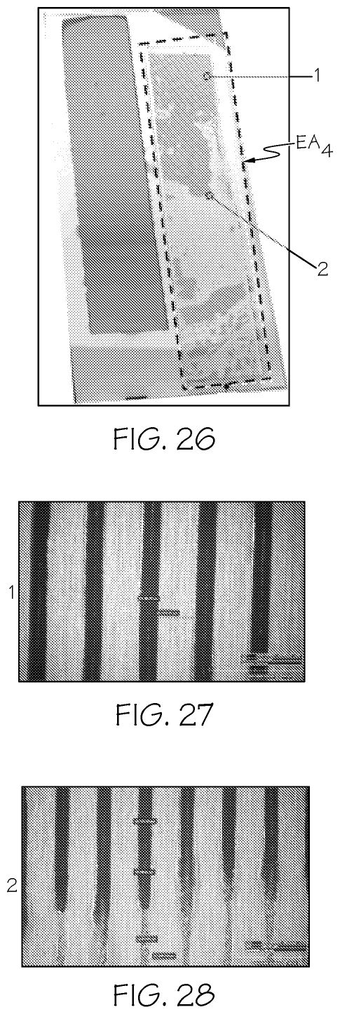

Referring now to FIGS. 26-28, an 80 μm thick copper foil tape having a 50 nm chromium adhesion layer was adhered to a 2.1 μm thick piece of aluminum foil. The multi-layer metal foil was pressed against a 0.7 mm EAGLE XG® (alkaline earth boro-aluminosilicate) glass substrate. Example welded article EA₄ was welded using the Condition C laser bond conditions and an energy density of 1.13 J/cm². The laser was directed through the glass substrate to focus on the interface between the glass substrate and the chromium adhesion layer.

The results are shown in FIGS. 26-28, which reveal the same larger spatial extent of the good bonding regions compared with the poor or non-bonding regions. Specifically. FIG. 26 is a photograph of example welded article EAs showing the result of sweeping the laser over the face of the entire Cu-foil-tape sample using Condition C. Note how the laser bonded regions appeared as dark lines in the dashed inset area, to include smaller areas towards the bottom of the sample. FIG. 27 is a high resolution microscope image showing good bonding regions that exhibited consistent weld lines with similar spatial extent and homogeneous appearance. Note the weld line widths in this area were again about 100 μm. FIG. 28 is a high resolution microscope image shows the transition from a good to poor bonding region exhibiting a tapering weld line width from the about μm micron good welding region to a poor or non-bonding region with much diminished attempted weld line widths.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A method of bonding glass to metal foil, the method comprising:
contacting a glass substrate and a metal foil to create an interface therebetween; and
directing a laser beam operating at a predetermined wavelength onto the interface to form an interfacial weld between the glass substrate and the metal foil,
wherein the metal foil has a thickness greater than or equal to 5 μm and less than or equal to 200 μm, and
wherein the laser beam comprises a pulsed laser having a pulse width greater than or equal to 1 nanosecond and less than or equal to 200 nanoseconds.

2. The method of claim 1, wherein the interfacial weld is a hermetic seal between the glass substrate and the metal foil.

3. The method of claim 1, wherein the pulsed laser comprises a wavelength greater than or equal 260 nm and less than or equal to 2500 nm.

4. The method of claim 1, wherein the pulsed laser comprises a repetition rate greater than or equal to 1 kHz and less than or equal to 1000 kHz.

5. The method of claim 1, wherein the pulsed laser comprises a focal spot diameter greater than or equal to 5 μm and less than or equal to 300 μm.

6. The method of claim 1, wherein: (i) the pulsed laser comprises an energy density greater than or equal to 0.1 J/cm² and less than or equal to 100 J/cm²; or (ii) the pulsed laser comprises a peak power density greater than or equal to 0.005 GW/cm² and less than or equal to 10 GW/cm²; or (iv) the pulsed laser has a peak power greater than or equal to 50 W and less than or equal to 10 kW; or (v) pulsed laser has an average power greater than or equal to 0.5 W and less than or equal to 5 W at 30 kHz repetition rate.

7. (canceled)

8. (canceled)

9. (canceled)

10. The method of claim 1, wherein the method further comprises forming a pattern on the metal foil after forming the interfacial weld.

11. The method of claim 1, wherein the glass substrate comprises a glass or glass-ceramic comprising silica, soda-lime silicate, aluminosilicate, alkali-aluminosilicate, borosilicate, alkali-borosilicate, aluminoborosilicate, and alkali-alumino-borosilicate, or alkali-aluminosilicate.

12. The method of claim 1, wherein the metal foil comprises aluminum or an aluminum alloy.

13. A welded article comprising:
a first glass substrate;
a metal foil;
a first interfacial weld between the first glass substrate and the metal foil,
wherein the metal foil has a thickness greater than or equal to 5 μm and less than or equal to 200 μm, and
wherein the first interfacial weld comprises weld lines having a width greater than or equal to 5 μm and less than or equal to 1 mm and a distance between weld lines greater than or equal to 1 μm and less than or equal to 1000 μm.

14. The welded article of claim 13, wherein the welded article has a surface energy bond strength greater than or equal to 0.2 J/m² and less than or equal to 3.0 J/m².

15. The welded article of claim 13, wherein the welded article has a residual stress less than or equal to 30 MPa.

16. The welded article of claim 13, wherein the first interfacial weld is a hermetic seal between the first glass substrate and the metal foil.

17. The welded article of claim 13, wherein the metal foil is a patterned metal foil.

18. The welded article of claim 13, wherein the welded article further comprises a second glass substrate and a second interfacial weld between the second glass substrate and the metal foil.

19. The welded article of claim 13, wherein the first glass substrate comprises a glass or glass-ceramic comprising silica, soda-lime silicate, aluminosilicate, alkali-aluminosilicate, borosilicate, alkali-borosilicate, aluminoborosilicate, and alkali-alumino-borosilicate, or alkali-aluminosilicate.

20. The welded article of claim 13, wherein the metal foil comprises aluminum or an aluminum alloy.

21. A method of bonding glass to metal foil, the method comprising:
contacting a glass substrate and a metal foil to create an interface therebetween; and
directing a laser beam operating at a predetermined wavelength onto the interface to form an interfacial weld between the glass substrate and the metal foil,
wherein the metal foil has a thickness greater than 100 nm and less than or equal to 10 mm, and
wherein the laser beam comprises a pulsed laser having a pulse width greater than or equal to 1 nanosecond and less than or equal to 200 nanoseconds.

22. The method of claim 21, wherein the interfacial weld is a hermetic seal between the glass substrate and the metal foil.

23. The method of claim 21, wherein the pulsed laser comprises: (i) a wavelength greater than or equal 260 nm and less than or equal to 2500 nm;
and/or (ii) a repetition rate greater than or equal to 1 kHz and less than or equal to 1000 kHz;
and/or (iii) a focal spot diameter greater than or equal to 5 μm and less than or equal to 300 μm; and/or (iv) an energy density greater than or equal to 0.1 J/cm² and less than or equal to 100 J/cm²; and/or (v) wherein the pulsed laser comprises a peak power density greater than or equal to 0.005 GW/cm² and less than or equal to 10 GW/cm².

24. (canceled)

25. (canceled)

26. (canceled)

27. (canceled)

28. The method of claim 21, wherein:
(i) the pulsed laser has a peak power greater than or equal to 50 W and less than or equal to 10 kW; or
(ii) the pulsed laser has an average power greater than or equal to 0.5 W and less than or equal to 5 W at 30 kHz repetition rate.

29. (canceled)

30. The method of claim 21, wherein the method further comprises forming a pattern on the metal foil after forming the interfacial weld.

31. The method of claim 21, wherein the metal foil comprises a first metal layer and a second metal layer.

32. (canceled)

33. The method of claim 31, wherein:
(i) the first metal layer comprises aluminum, manganese, tantalum, chromium, cobalt, magnesium, iron, titanium, or a combination thereof; or
(ii) the second metal layer comprises copper, silver, gold, molybdenum, titanium, aluminum, stainless steel, nickel, tungsten, bronze, iron, any alloy thereof, or a combination thereof.

34. The method of claim 31, wherein: (i) the first metal layer has a thickness greater than or equal to 10 nm and less than or equal to 15 μm; or (ii) the second metal layer has a thickness greater than or equal to 100 nm and less than or equal to 10 mm.

35. (canceled)

36. The method of claim 31, wherein the metal foil further comprises a first metal adhesion layer between the first metal layer and the second metal layer.

37. The method of claim 36, wherein the first metal adhesion layer comprises chromium, tungsten, tantalum, titanium, niobium, any alloy thereof, or a combination thereof.

38. The method of claim 36, wherein the first metal adhesion layer has a thickness greater than or equal to 1 nm and less than or equal to 250 nm.

39. The method of claim 21, wherein the glass substrate comprises a glass or glass-ceramic comprising silica, soda-lime silicate, aluminosilicate, alkali-aluminosilicate, borosilicate, alkali-borosilicate, aluminoborosilicate, and alkali-alumino-borosilicate, alkali-aluminosilicate, or inorganic oxide.

40. A welded article comprising:
a first glass substrate;
a metal foil;
a first interfacial weld between the first glass substrate and the metal foil,
wherein the metal foil has a thickness greater than 100 nm and less than or equal to 10 mm, and
wherein the first interfacial weld comprises weld lines having a width greater than or equal to 5 μm and less than or equal to 1 mm and a distance between weld lines greater than or equal to 1 μm and less than or equal to 1000 μm.

41. The welded article of claim 40, wherein the welded article has a surface energy bond strength greater than or equal to 0.2 J/m² and less than or equal to 3.0 J/m².

42. The welded article of claim 40, wherein: (i) the welded article has a residual stress less than or equal to 50 MPa; or (ii) wherein the first interfacial weld is a hermetic seal between the first glass substrate and the metal foil; or (iii) wherein the metal foil is a patterned metal foil.

43. (canceled)

44. (canceled)

45. The welded article of claim 40, wherein: (i) the welded article further comprises a second glass substrate and a second interfacial weld between the second glass substrate and the metal foil; or (ii) wherein the metal foil comprises a first metal layer and a second metal layer.

46. (canceled)

47. (canceled)

48. (canceled)

49. (canceled)

50. (canceled)

51. (canceled)

52. (canceled)

53. (canceled)

54. (canceled)
